(19) United States
(12) Patent Application Publication
(10) Pub. No.: US 2022/0070516 A1
(43) Pub. Date: Mar. 3, 2022

(54) VIDEO PROGRAM PLAYING DEVICE AND VIDEO PROGRAM SHIELDING METHOD THEREOF

(71) Applicant: REALTEK SEMICONDUCTOR CORP., Hsinchu (TW)

(72) Inventor: Hui-Dong Zhang, Hsinchu (TW)

(73) Assignee: REALTEK SEMICONDUCTOR CORP., Hsinchu (TW)

(21) Appl. No.: 17/136,971

(22) Filed: Dec. 29, 2020

(30) Foreign Application Priority Data
Aug. 28, 2020 (CN) 202010884613.1

(51) Int. Cl. H04N 21/258; G06K 9/00

(52) U.S. Cl. CPC H04N 21/25883; G06K 2009/00322; G06K 9/00228; G06K 9/00362

(57) ABSTRACT

A video program playing device implements a video program shielding method. The video program shielding method includes receiving a video program signal and predetermined age information, and obtaining video program information from the video program signal; determining, according to the video program information, whether the video program signal matches the predetermined age information; determining whether at least one target meeting the predetermined age information is detected within a predetermined range of a video program playing device; and stopping outputting the video program signal when the video program signal fails to match the predetermined age information and the at least one target is detected.

### CROSS-REFERENCE TO RELATED APPLICATION

This non-provisional application claims priority under 35 U.S.C. § 119(a) to Patent Application No. 202010884613.1 filed in China, P.R.C. on Aug. 28, 2020, the entire contents of which are hereby incorporated by reference.

### BACKGROUND

### Technical Field

The present invention relates to a video program playing device and a video program shielding method thereof.

### Related Art

With the advancement of science and technologies, various online streaming (including video and/or audio) platforms have been developed nowadays. A user can watch and select video programs provided by the streaming platforms on a computer or a television at any time and at anywhere. It greatly meets entertainment demands of people. Consequently, such convenience brought by the online streaming platforms increases the time people watching video programs. As a result, exposure of excessive sounds and lights from the streams can cause concentration problems or even hyperactivity disorder in children.

Therefore, a playing device with a child lock has been developed nowadays. Parents can lock the playing device through the child lock, and the locked playing device cannot play audio-video signals. This prevents children from watching video programs freely. However, even if there is no child in front of the playing device, after the playing device is locked, the parents need to manually unlock the child lock before they can watch video programs. In addition, if a child shows up while the parents are watching video programs, children could watch the video programs as well. To prevent this, the parents need to activate the child lock again. Such playing device is quite inconvenient to the parents.

### SUMMARY

In some embodiments, a video program shielding method includes receiving a video program signal and predetermined age information, and obtaining video program information from the video program signal; determining, according to the video program information, whether the video program signal matches the predetermined age information; determining whether at least one target matching the predetermined age information is detected within a predetermined range of a video program playing device; and stopping outputting the video program signal when the video program signal fails to match the predetermined age information and the at least one target is detected.

In some embodiments, a video program playing device includes a shield setting unit and a video program signal processing unit. The shield setting unit generates predetermined age information according to a predetermined age. The video program signal processing unit is coupled with the shield setting unit. The video program signal processing unit analyzes a video program signal generated by a video program signal source, to obtain video program information of the video program signal. The video program signal processing unit determines, according to the video program information, whether the video program signal matches the predetermined age information. The video program signal processing unit determines whether at least one target matching the predetermined age information is detected within a predetermined range of the video program playing device. The video program signal processing unit stops outputting the video program signal when the video program signal fails to match the predetermined age information and the at least one target is detected.

### BRIEF DESCRIPTION OF THE DRAWINGS

FIG. 1 is a functional block diagram of an embodiment of a video program playing device according to the present invention.

FIG. 2 is a flowchart of an embodiment of a video program shielding method according to the present invention.

### DETAILED DESCRIPTION

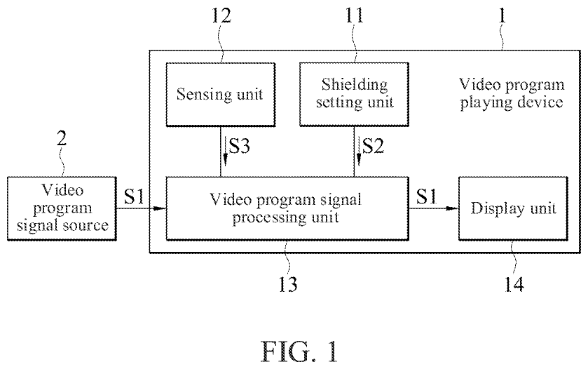

FIG. 1 is a functional block diagram of an embodiment of a video program playing device 1 according to the present invention. Referring to FIG. 1, the video program playing device 1 is coupled with a video program signal source 2, and receives a video program signal S1 from the video program signal source 2 and plays the same. The video program playing device 1 has a child lock function. A user (for example, parent) of the video program playing device 1 may set the child lock for a to-be-shielded age of children. The to-be-shielded age of children may be a specific age or a specific age range, for example, but not limited to, 18 years old, or 5-6 years old. The to-be-shielded age of children is a predetermined age information S2. The video program playing device 1 determines, according to the to-be-shielded age of children, whether to output the video program signal S1. This prevents child whose age matches the to-be-shielded age of children from watching excessive or inappropriate video programs. In some embodiments, a video program is a visual medium with audio, a visual medium without audio (e.g. a set of images), an audio, or data regarding video and audio displaying.

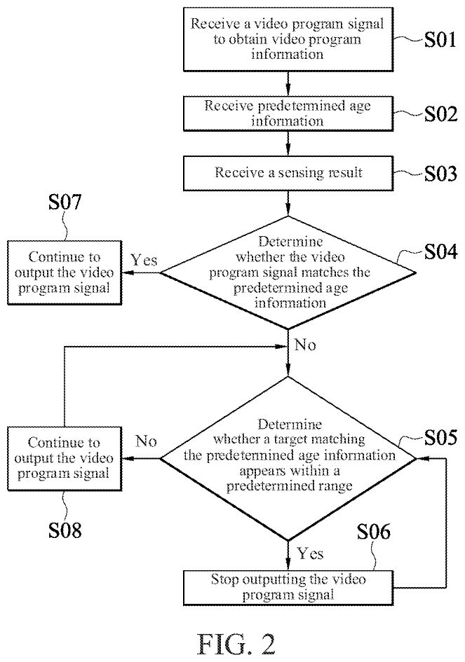

In detail, the video program playing device 1 includes a shield setting unit 11, a sensing unit 12, and a video program signal processing unit 13. The video program signal processing unit 13 is coupled with the shield setting unit 11 and the sensing unit 12. The user of the video program playing device 1 sets a predetermined age by the shield setting unit 11, and the shield setting unit 11 generates the predetermined age information S2 according to the predetermined age. The sensing unit 12 senses the environment within a predetermined range from the location of the video program playing device 1 to generate a sensing result S3. Referring to FIG. 1 and FIG. 2, the video program signal processing unit 13 receives the video program signal S1 from the video program signal source 2 (step S01), the predetermined age information S2 from the shield setting unit 11 (step S02), and the sensing result S3 from the sensing unit 12 (step S03). There is no specific order between step S02 and step S03. The two steps can be interchangeable in order or parallel steps. The schematic diagram is for ease of description. The video program signal processing unit 13 analyzes the video program signal S1 in step S01, and the video program signal S1 includes video program information. The video program signal processing unit 13 obtains the video program information (e.g., encoded in PSIP protocol in ATSC systems, or service information in DVB systems) from the video program signal S1 after analyzing the video program signal S1, and determines, according to the video program information and the predetermined age information S2, whether the video program signal S1 matches the predetermined age information S2 (step S04). That is, the video program signal processing unit 13 determines whether the video program signal S1 matches the to-be-shielded age of children set by the user.

Moreover, the video program signal processing unit 13 analyzes the sensing result S3 to determine if there is any specific target (e.g. a specific human being or specific program viewer) in the predetermined range from the video program playing device 1. Specifically, the sensing result S3 may indicate all possible program viewers (targets) or no program viewers within the predetermined range. The video program signal processing unit 13 determines, based on the sensing result S3, whether any of the targets (all possible program viewers) matches the predetermined age information S2. That is, the video program signal processing unit 13 determines, according to the sensing result S3 and the predetermined age information S2, whether at least one target matching the predetermined age information S2 is in the predetermined range (step S05). According to determining results of step S04 and step S05, when the video program signal S1 fails to match the predetermined age information S2 and at least one target within the predetermined range matches the predetermined age information S2, the video program signal processing unit 13 stops (or pauses) the output of the video program signal S1 (step S06).

Based on this, the video program signal processing unit 13 may automatically determine, according to the predetermined age information S2 set by the user, whether any target within the predetermined range matches the predetermined age information S2 to decide whether (or not) to stop outputting the video program signal S1. As a result, the user of the video program playing device 1 does not need to set the child lock manually. It greatly improves user experience, and greatly reduces the opportunity for children to be exposed to inappropriate video programs.

In some embodiments, the video program information included in the video program signal S1 may indicate a video program category, for example, an entertainment type, an education type, a news type, a violence type, or a pornography type. In step S04, the video program signal processing unit 13 may determine, according to different video program information, whether the video program signal S1 matches the predetermined age information S2 set by the user. For example, the video program playing device 1 may store a list of viewable categories matching all ages of children. For example, a list of viewable categories matching ages over three years old (hereinafter referred to as a first category list) may include the entertainment type and the education type. A list of viewable categories meeting ages over six years old (hereinafter referred to as a second category list) may include the entertainment type, the education type, and the news type. After receiving the predetermined age information S2, the video program playing device 1 may determine that a list of viewable categories corresponding to the predetermined age information S2 is the first category list or the second category list, and the video program signal processing unit 13 determines whether the video program category of the video program signal S1 is listed in the list of viewable categories corresponding to the predetermined age information S2. The video program signal processing unit 13 determines that the video program signal S1 fail to match the predetermined age information S2 in step S04 (the determining result shows “No”) when the video program category of the video program signal S1 is not listed in the list of viewable categories corresponding to the predetermined age information S2. The video program signal processing unit 13 determines that the video program signal S1 matches the predetermined age information S2 in step S04 (the determining result is “Yes”) when the video program category of the video program signal S1 is listed in the list of viewable categories corresponding to the predetermined age information S2.

For example, the predetermined age information S2 directs to three years old, and it is determined that the list of viewable categories corresponding to the predetermined age information S2 is the first category list according to the video program signal S1. If video program information of the video program signal S1 indicates that the video program signal S1 corresponds to the education type, the video program signal processing unit 13 determines that the video program information of the “education type” is listed in the first category list in step S04, and determines that the video program signal S1 matches the predetermined age information S2 (three years old) (the determining result shows “Yes”). If video program information of the video program signal S1 indicates that the video program signal S1 corresponds to the news type, the video program signal processing unit 13 determines that the video program information of the “news type” is not listed in the first category list in step S04, and determines that the video program signal S1 fails to match the predetermined age information S2 (three years old) (the determining result shows “No”).

In some embodiments, the video program information included in the video program signal S1 may indicate a viewable age corresponding to a video program rating system. For example, a viewable age corresponding to general-rated of the video program rating system is an age over 0. A viewable age corresponding to protection-rated of the video program rating system is an age over six years old. In step S01, after analyzing the video program signal S1 and obtaining a viewable age, the video program signal processing unit 13 may compare the viewable age with the predetermined age information S2 in step S04 and determines that the video program signal S1 fail to match the predetermined age information S2 (the determining result is “No”) when the predetermined age information S2 indicates an age less than the viewable age. The video program signal processing unit 13 determines that the video program signal S1 matches the predetermined age information S2 (the determining result is “Yes”) when the predetermined age information S2 is equal to or greater than the viewable age. For example, the predetermined age information S2 is three years old. If a viewable age of the video program signal S1 is an age over 0, the video program signal processing unit 13 determines that the video program signal S1 matches the predetermined age information S2 (three years old) in step S04 (the determining result shows “Yes”). If a viewable age of the video program signal S1 is an age over six years old, the video program signal processing unit 13 determines that the video program signal S1 fails to match the predetermined age information S2 (three years old) in step S04 (the determining result shows “No”).

In some embodiments, the sensing unit 12 may be an image capture unit, for example, a video camera or a camera. The sensing unit 12 may capture an image within the predetermined range of the video program playing device 1, to generate a sensing result S3 (which can be an image). The video program signal processing unit 13 receives the sensing result S3 (i.e., the image) from the sensing unit 12. In step S05, the video program signal processing unit 13 perform image analysis according to the sensing result S3 to determine whether a target matches the predetermined age information S2. For example, the video program signal processing unit 13 determines, according to the sensing result S3, whether the image includes a human body image. When the human body image is included, the video program signal processing unit 13 determines, according to a contour of the human body image, age information corresponding to the human body image. For example, the video program signal processing unit 13 determine, according to the contour, a height corresponding to the human body image, to determine the age information corresponding to the human body image. The video program signal processing unit 13 then determines whether the age information corresponding to the human body image matches the predetermined age information S2. The video program signal processing unit 13 determines that the target (within the predetermined range) matches the predetermined age information S2 (the determining result shows “Yes) when the age information corresponding to the human body image matches the predetermined age information S2, and then the video program signal processing unit 13 stops outputting the video program signal S1 (step S06).

Alternatively, in step S05, after determining that the image includes the human body image, the video program signal processing unit 13 compares a contour of the human body image included in the sensing result S3 with a contour of a predetermined image corresponding to the predetermined age information S2. The video program signal processing unit 13 determines that the target matches the predetermined age information S2 in step S04 (the determining result is “Yes”) when the human body image included in the sensing result S3 matches the predetermined image corresponding to the predetermined age information S2 (for example, the two images have a substantially consistent height), and then the video program signal processing unit 13 stops outputting the video program signal S1 (step S06). Alternatively, in step S05, the video program signal processing unit 13 performs a face recognition technology to analyze the sensing result S3 to determine whether the image includes a human body image. If the video program signal processing unit 13 determines that the image includes a human body image, the video program signal processing unit 13 identifies and analyzes a face image of the human body image by using the face recognition technology to determine age information corresponding to the face image by using the face recognition technology. Then, the video program signal processing unit 13 compares the age information corresponding to the face image with the predetermined age information S2, to determine whether the target matches the predetermined age information S2.

In some embodiments, the video program signal processing unit 13 may further determine a line-of-sight of the human body image. When determining that the target matches the predetermined age information S2 in step S04 (the determining result is “Yes”) and a line-of-sight of the target directs to the video program playing device 1 (for example, toward the sensing unit 12), the video program signal processing unit 13 stops outputting the video program signal S1 that fails to match the predetermined age information S2. That is, if a line-of-sight of a child is not directed to the video program playing device 1, the video program playing device 1 may still continue to output the video program signal S1.

In some embodiments, when determining whether the sensing result S3 includes the human body image, the video program signal processing unit 13 may compare a plurality of sensing results S3 generated sequentially by the sensing unit 12 at different time points, to determine whether a plurality of images of the plurality of sensing results S3 change. The video program signal processing unit 13 determines that the images of the sensing results S3 include the human body image when any change among the plurality of images is found (because a human body is movable, but an inorganic object is not).

In some embodiments, the sensing unit 12 may be a sound capture unit. The sensing unit 12 may capture an environmental sound within a predetermined range of the video program playing device 1, to generate a sensing result S3 (which can be the environmental sounds). The video program signal processing unit 13 receives the sensing result S3 from the sensing unit 12. In step S05, the video program signal processing unit 13 determines a volume value of the sensing result S3 and compares the volume value of the sensing result S3 with a threshold. When the volume value of the sensing result S3 is greater than the threshold, it may indicate that noise made by a child appears within the predetermined range. The video program signal processing unit 13 determines that a target matches the predetermined age information S2 (the determining result shows “Yes”), and then stops outputting the video program signal S1 (step S06). In some embodiments, the video program signal processing unit 13 determines whether the target matches the predetermined age information S2 by determining a voiceprint of a human voice included in the sensing result S3, and determine whether to stop outputting the video program signal S1.

In some embodiments, the video program signal S1 is a video-audio signal, that is, the video program signal S1 includes an image signal and a sound signal. In step S06, the video program signal processing unit 13 may stop outputting the image signal and the sound signal of the video program signal S1, or may stop outputting the sound signal of the video program signal S1 but continue to output the image signal of the video program signal S1, or may stop outputting the image signal of the video program signal S1 but continue to output the sound signal of the video program signal S1. It is understood that a selection of outputting or stopping outputting the audio-video signal may be set by the user.

In some embodiments, after the video program signal processing unit 13 stops outputting the video program signal S1 (step S06), the sensing unit 12 may continue to capture a sound or an image within the predetermined range from the video program playing device 1, and generate a sensing result S3 (the sound or the image). After stopping outputting the video program signal S1, the video program signal processing unit 13 may continue to perform step S05, to continue to determine, according to the sensing result S3, whether a target matches the predetermined age information S2. In other words, after stopping outputting the video program signal S1, the video program signal processing unit 13 may perform step S05 to determine whether the target meeting the predetermined age information S2 leaves the predetermined range. When the video program signal processing unit 13 determines that the target meeting the predetermined age information S2 does not appear within the predetermined range (the determining result shows “No”), it indicates that the target matching the predetermined age information S2 has left the predetermined range, and the video program signal processing unit 13 then performs step S08 to continue to output the video program signal S1. In this case, the video program signal processing unit 13 may wait for a predetermined delay time, and continue to output the video program signal S1 after the predetermined delay time (step S08). For example, after determining that the target matching the predetermined age information S2 has left the predetermined range, the video program signal processing unit 13 may wait for the predetermined delay time of 10 seconds, and after the predetermined delay time of 10 seconds passed, the video program signal processing unit 13 continues to output the video program signal S1, so as to avoid a case that the target meeting the predetermined age information S2 leaves the predetermined range for a short time and then enters the predetermined range again. In some embodiments, after continuing to output the video program signal S1 in step S08, the video program signal processing unit 13 may perform step S05 again, to repeatedly determine whether the target matching the predetermined age information S2 appears within the predetermined range, and start to stop outputting the video program signal S1 (step S06) until the target matching the predetermined age information S2 appears within the predetermined range.

In some embodiments, the video program playing device 1 may further include a display unit 14, where the display unit 14 is coupled with the video program signal processing unit 13. The video program signal processing unit 13 outputs the video program signal S1 to the display unit 14, and the display unit 14 plays the video program signal S1.

In some embodiments, when determining that the video program signal S1 matches the predetermined age information S2 (the determining result shows “Yes”) in step S04, the video program signal processing unit 13 continues to output the video program signal S1 (step S07) but not shield the video program signal S1. Moreover, when determining that the target matching the predetermined age information S2 does not appear within the predetermined range (the determining result is “No”) in step S05, for example, if there is no target within the predetermined range or the age of the target is greater than the predetermined age information S2, the video program signal processing unit 13 continues to output the video program signal S1 (step S08) instead of shielding the video program signal S1.

In some embodiments, the sensing unit 12 may actively capture a sound or an image within the predetermined range, and actively send a sensing result S3 to the video program signal processing unit 13. The video program signal processing unit 13 determines, according to the sensing result S3, whether a target matches the predetermined age information S2 (step S05). Alternatively, the sensing unit 12 may wait for the video program signal processing unit 13 to send a start command. After the video program signal processing unit sends the start command to the sensing unit 12, the sensing unit 12 starts to capture a sound or an image within the predetermined range, and transmits a sensing result S3 back to the video program signal processing unit 13. That is, the sensing unit 12 may be a passive unit triggered by the video program signal processing unit 13 to capture the sound or the image within the predetermined range.

In some embodiments, the video program playing device 1 may be a television, a computer, a mobile phone, or a tablet. The shield setting unit 11 and the video program signal processing unit 13 may be implemented by a microcontroller unit (MCU), a central processing unit (CPU), an embedded controller (EC), or an application-specific integrated circuit (ASIC), and the hardware is provided with software or firmware for performing the functions.

In conclusion, according to the embodiments of the video program playing device and the video program shielding method thereof of the present invention, the video program playing device may automatically determine whether a child is in a predetermined range and automatically stop outputting a video program signal. A user of the video program playing device does not need to manually set a child lock. In some embodiments, after the output of the video program signal is stopped, the video program playing device may automatically continue to output the video program signal after the child leaves. The user does not need to manually unlock the child lock. It greatly improves convenience in use and greatly reduces the opportunity for children to be exposed to the video programs.

What is claimed is:

1. A video program shielding method, comprising:
receiving a video program signal and predetermined age information, and obtaining video program information from the video program signal;
determining, according to the video program information, whether the video program signal matches the predetermined age information;
determining whether at least one target matching the predetermined age information is detected within a predetermined range from a video program playing device; and
stopping outputting the video program signal when the video program signal fails to match the predetermined age information and the at least one target is detected.

2. The video program shielding method according to claim 1, wherein the video program information is a video program category, and the step of determining whether the video program signal matches the predetermined age information is to determine, according to the video program category, whether the video program signal matches the predetermined age information.

3. The video program shielding method according to claim 1, wherein the video program information is a viewable age corresponding to a video program rating system, and the step of determining whether the video program signal matches the predetermined age information comprises:
comparing the viewable age with the predetermined age information; and
determining that the video program signal fails to match the predetermined age information when the predetermined age information shows an age less than the viewable age.

4. The video program shielding method according to claim 1, further comprising:
determining whether the at least one target is still detected within the predetermined range after the output of the video program signal is stopped; and
outputting the video program signal when the at least one target is not detected within the predetermined range.

5. The video program shielding method according to claim 1, wherein the video program signal comprises an image signal and a sound signal, and the step of stopping outputting the video program signal comprises:
continuing to output the image signal; and
stopping outputting the sound signal.

6. The video program shielding method according to claim 1, wherein the step of determining whether the at least one target is detected within the predetermined range comprises:
capturing an image within the predetermined range;
performing a face recognition technology, to determine whether the image within the predetermined range comprises a face image;
when the image within the predetermined range comprises the face image, performing the face recognition process to determine age information corresponding to the face image; and
comparing the age information with the predetermined age information, in order to determine whether the at least one target matching the predetermined age information is detected within the predetermined range.

7. The video program shielding method according to claim 1, wherein the step of determining whether the at least one target is detected within the predetermined range comprises:
capturing an image within the predetermined range;
determining whether the image within the predetermined range comprises a human body image; and
when the image within the predetermined range comprises the human body image, determining, according to the human body image and a predetermined image corresponding to the predetermined age information, whether the at least one target matching the predetermined age information is detected within the predetermined range.

8. The video program shielding method according to claim 1, wherein the step of determining whether the at least one target is detected within the predetermined range comprises:
capturing a plurality of images within the predetermined range;
determining whether the plurality of images within the predetermined range comprises a human body image according to whether any change among the plurality of images is found;
when the plurality of images comprises the human body image, determining age information corresponding to the human body image; and
determining, according to the predetermined age information and the age information corresponding to the human body image, whether the at least one target matching the predetermined age information is detected within the predetermined range.

9. The video program shielding method according to claim 1, wherein the step of determining whether the at least one target is detected within the predetermined range comprises:
capturing an environmental sound within the predetermined range; and
comparing a volume of the environmental sound with a threshold, to determine whether the at least one target matching the predetermined age information is detected within the predetermined range.

10. A video program playing device, comprising:
a shield setting unit, configured to generate predetermined age information according to a predetermined age; and
a video program signal processing unit, coupled with the shield setting unit, and configured to
analyze a video program signal generated by a video program signal source, to obtain video program information of the video program signal, and
determine, according to the video program information, whether the video program signal matches the predetermined age information,
wherein the video program signal processing unit determines whether at least one target matching the predetermined age information is detected within a predetermined range from the video program playing device, and stops outputting the video program signal when the video program signal fails to match the predetermined age information and the at least one target is detected.

11. The video program playing device according to claim 10, wherein the video program information is a video program category, and the video program signal processing unit determines, according to the video program category, whether the video program signal matches the predetermined age information.

12. The video program playing device according to claim 10, wherein the video program information is a viewable age corresponding to a video program rating system, and the video program signal processing unit compares the viewable age with the predetermined age information, and when the predetermined age information is less than the viewable age, the video program signal processing unit determines that the video program signal fails to match the predetermined age information.

13. The video program playing device according to claim 10, wherein the video program signal processing unit determines whether the at least one target leaves the predetermined range after stopping outputting the video program signal, and resume to output the video program signal after the at least one target leaves the predetermined range.

14. The video program playing device according to claim 10, wherein the video program signal comprises an image signal and a sound signal, and the video program signal processing unit stops outputting the sound signal when the video program signal fails to match the predetermined age information and the at least one target is detected.

15. The video program playing device according to claim 10, further comprising an image capture unit, coupled with the video program signal processing unit, wherein the image capture unit captures an image within the predetermined range, and the video program signal processing unit is configured to
perform a face recognition process to determine whether the image comprises a face image;
perform the face recognition process to determine age information corresponding to the face image when the image within the predetermined range comprises the face image; and
compare the age information with the predetermined age information, in order to determine whether the at least one target meeting the predetermined age information appears within the predetermined range.

16. The video program playing device according to claim 10, further comprising an image capture unit, coupled with the video program signal processing unit, wherein the image capture unit is configured to capture an image within the predetermined range, and the video program signal processing unit is configured to
determine whether the image within the predetermined range comprises a human body image;
determine, when the image within the predetermined range comprises the human body image, according to the human body image and a predetermined image corresponding to the predetermined age information, whether the at least one target matching the predetermined age information appears within the predetermined range.

17. The video program playing device according to claim 10, further comprising an image capture unit, coupled with the video program signal processing unit, wherein the image capture unit is configured to capture a plurality of images within the predetermined range, and the video program signal processing unit is configured to
determine whether any change among the plurality of images is found, to determine whether the image within the predetermined range comprises a human body image;
determine, when the image within the predetermined range comprises the human body image, age information corresponding to the human body image; and
determine, according to the predetermined age information and the age information corresponding to the human body image, whether the at least one target matching the predetermined age information appears within the predetermined range.

18. The video program playing device according to claim 10, further comprising a sound capture unit, coupled with the video program signal processing unit, wherein the sound capture unit is configured to capture an environmental sound within the predetermined range, and compare a volume of the environmental sound with a threshold, to determine whether the at least one target matching the predetermined age information appears within the predetermined range.
